(19) United States
(12) Patent Application Publication
(10) Pub. No.: US 2010/0178415 A1
(43) Pub. Date: Jul. 15, 2010

(54) METHOD FOR SEASONING PLASMA PROCESSING APPARATUS, AND METHOD FOR DETERMINING END POINT OF SEASONING

(75) Inventors: Yasuhiro NISHIMORI, Hikari-shi (JP); Hiroshige UCHIDA, Kudamatsu-shi (JP); Masamichi SAKAGUCHI, Kudamatsu-shi (JP); Kousa HIROTA, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/396,699

(22) Filed: Mar. 3, 2009

(30) Foreign Application Priority Data
Jan. 13, 2009 (JP) 2009-004964

(51) Int. Cl. B05D 1/00

(52) U.S. Cl. 427/8; 427/569

(57) ABSTRACT

The invention provides a method for determining an end point of seasoning of a plasma processing apparatus capable of reducing the time required for seasoning after performing wet cleaning and determining the optimum end point of seasoning with superior repeatability. The present method comprises, after performing wet cleaning (S501) of the plasma processing apparatus, using a processing gas containing SF6 as processing gas and applying an RF bias double that of mass production conditions to perform seasoning (S502), acquiring emission data of SiF and Ar during plasma processing using test conditions using SiF and Ar gases (S503), determining whether the computed value of emission intensities during seasoning is equal to or smaller than the computed value of emission intensities during stable mass production (S504), and determining the endpoint of the seasoning process when the value is determined to be equal or smaller.

The present application is based on and claims priority of Japanese patent application No. 2009-004964 filed on Jan. 13, 2009, the entire contents of which are hereby incorporated by reference.

### BACKGROUND OF THE INVENTION

1. Field of the Invention

The present invention relates to a method for seasoning a plasma processing apparatus, and more specifically, relates to a method for seasoning a plasma processing apparatus and a method for determining an end point of seasoning after performing wet cleaning, capable of starting up the apparatus at an early stage after wet cleaning in a semiconductor manufacturing process.

2. Description of the Related Art

Recently, along with the further improvement in integration of devices, particles and contamination substances generated during plasma processing have become a serious problem causing product failure, even though the size thereof may be minute. Further, along with the increase in size of the objects to be processed, the in-plane uniformity of plasma processing has also become a serious issue.

In order to cope with the problem of particles and contamination substances, the earth portion provided on the inner wall of the processing chamber (hereinafter referred to as inner wall earth portion in the processing chamber) is either formed of a plasma-resistance material including aluminum (Al) having aluminum oxide (Al₂O₃) as the main component, or yttrium (Y) having yttrium oxide (Y₂O₃) or yttrium fluoride (YF₃) as the main component, or is coated with the above-mentioned mixed materials. Further, a component using a material including silicon (Si) is adopted to form a part of the processing chamber.

In a plasma processing apparatus having the interior of the processing chamber formed as described above, along with the increase in the number of samples being subjected to plasma processing, the nonvolatile reaction products generated during plasma processing are attached to the inner wall earth portion of the processing chamber, and along with the increase in the number of samples being processed, the attached reaction products are gradually detached and are stuck as particles to the surface of the samples to be processed. Such particles cause product defects, leading to deterioration of yield of the semiconductor manufacturing process.

In order to overcome the above-mentioned defect, a process so-called wet cleaning is performed to remove the particles attached to the inner wall of the processing chamber by releasing the processing chamber to the air periodically to exchange consumed products and to remove the attached particles in the processing chamber. The atmosphere within the processing chamber after performing wet cleaning is different from the atmosphere during stable mass production, so as a result, the plasma processing performance was changed before and after wet cleaning.

Conventionally, in order to solve the problem, in general, a plasma process imitating the plasma processing state during mass production (hereinafter called seasoning) is performed to approximate the state within the processing chamber to the state during stable mass production. During seasoning, the plasma processing state during mass production is often imitated by subjecting a sample that is different from the product sample (hereinafter called a dummy wafer) to plasma processing.

Japanese patent application No. 2008-108427 (patent document 1) discloses an art to further overcome the above-mentioned method, providing a method of using an energy region exceeding the threshold of sputtering rate of the plasma-resistance material used for the inner wall earth portion in the processing chamber (hereinafter called an earth member), so as to enable the earth member to be emitted efficiently and to attach the earth member or reaction products containing the earth member to the surface of components containing silicon in the processing chamber.

One method for determining whether seasoning has been completed or not according to the above-mentioned art is to determine whether the etching rate (etching speed), the rate distribution (in-plane distribution of etching rate) and the number of particles within the processing chamber correspond to those during stable mass production, and another method proposed in Japanese patent application laid-open publication No. 2007-324341 (patent document 2) is to detect the pressure during seasoning, and determining that seasoning has been completed when the detected pressure being reduced along with plasma processing time has reached a stable value.

According to the above-mentioned prior arts, the time required for seasoning performed after wet cleaning is long, and even if the etching rate, the rate distribution and the number of particles within the processing chamber correspond to those during stable mass production, the critical dimension (hereinafter referred to as CD) may differ from that during stable mass production.

Moreover, even if seasoning is performed for a predetermined period of time, the seasoning may be excessive or deficient due to inter-chamber differences, differences in components during wet cleaning and differences in operation, so the determination of the optimum seasoning time has become an issue.

Further, in the field of mass production, there are demands to shorten the time required for seasoning and to determine the optimum seasoning time (seasoning process end time) from the viewpoint of cost reduction.

### SUMMARY OF THE INVENTION

The present invention solves the above-mentioned problems by providing a method for seasoning a plasma processing apparatus and a method for determining the end point of seasoning, capable of shortening the time required for seasoning and determining the optimum end point of seasoning with superior repeatability.

In order to solve the above-mentioned problems, the present invention provides a method for seasoning a plasma processing apparatus using a plasma-resistance material containing aluminum (Al) and yttrium (Y) as the inner wall earth portion of the processing chamber and having components using materials containing silicon (Si) in the processing chamber, wherein the conditions of seasoning after performing wet cleaning are controlled so that the energy of ions reaching the inner wall earth portion of the processing chamber exceeds the threshold of sputtering rate of the earth member in the processing chamber (the ratio between the number of incident ions and the number of particles emitted by the incident ions).

Further according to the present invention, the earth member can be emitted more efficiently by using a gas containing fluorine and nitrogen as seasoning gas and using RF bias power set to high power, by which the earth member or reaction products including the earth member can be attached sufficiently to the surface of components containing silicon within the processing chamber.

Moreover, the present invention provides a method for seasoning a plasma processing apparatus and a method for determining the end point of seasoning, capable of determining the optimum seasoning time with superior repeatability by observing in real time during seasoning the emission intensities of targets including fluorine-based gas and argon gas, and performing the end point determination in a same chamber atmosphere as the chamber atmosphere (surface state of silicon components) during stable mass production.

### BRIEF DESCRIPTION OF THE DRAWINGS

FIG. 1 is an explanatory view illustrating the outline of the structure of a plasma processing apparatus to which the present invention is applied;

FIG. 2 is a flowchart showing a prior art seasoning process;

FIG. 3 is a characteristic diagram (1) showing the relationship between the CD difference during seasoning and during stable mass production and the time required for the seasoning process, which illustrates the effect of embodiment 1 of the present invention;

FIG. 4 is an explanatory view modeling the assumed reaction within the processing chamber when subjecting a semiconductor wafer to plasma processing after performing seasoning according to the prior art;

FIG. 5 is an explanatory view modeling the assumed reaction within the processing chamber when subjecting a semiconductor wafer to plasma processing after performing seasoning according to the present invention;

FIG. 6 is a characteristic diagram (2) showing the relationship between the difference in CD during seasoning and during stable mass production and the time required for seasoning, which illustrates the effect of embodiment 2 of the present invention;

FIG. 7 is a flowchart showing the process for confirming the chamber atmosphere during stable mass production;

FIG. 8 is a flowchart showing the seasoning process after wet cleaning according to embodiment 2 of the present invention;

FIG. 9 is a characteristic diagram illustrating the relationship between the emission intensity during plasma processing using test conditions, the difference in CD during seasoning and during stable mass production and the time required for the seasoning process according to embodiment 2 of the present invention;

FIG. 10 is a flowchart showing the steps for computing the correlation between the emission intensities using seasoning conditions and test conditions according to embodiment 3 of the present invention;

FIG. 11 is a characteristic diagram illustrating the relationship between the emission intensity according to seasoning conditions, the emission intensity during plasma processing using test conditions, and the emission intensity during plasma processing using test conditions during stable mass production according to embodiment 3 of the present invention; and

FIG. 12 is a flowchart showing the process for performing seasoning after wet cleaning according to embodiment 3 of the present invention.

### DETAILED DESCRIPTION OF THE PREFERRED EMBODIMENTS

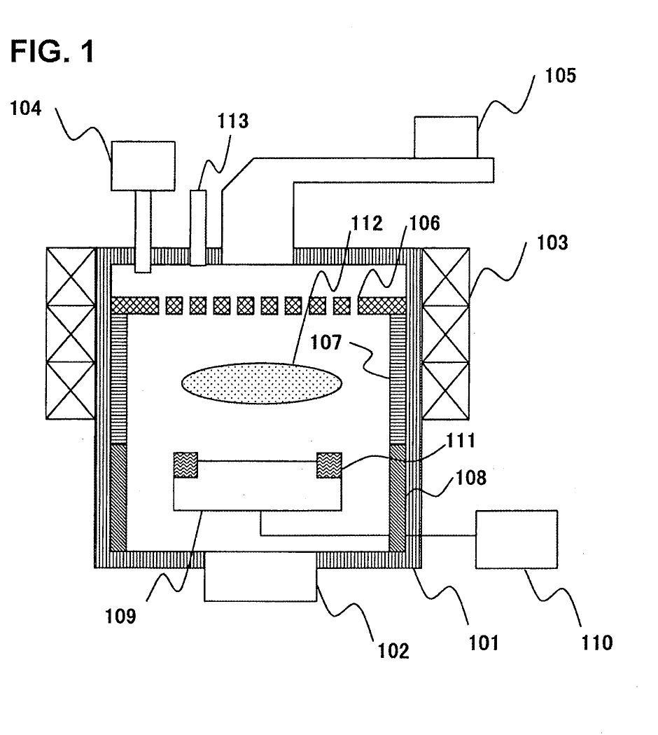

Now, the preferred embodiments for carrying out the present invention will be described with reference to FIGS. 1 through 12. The cross-sectional view of FIG. 1 is referred to in describing the outline of the structure of a plasma etching apparatus as an example of the plasma processing apparatus to which the present invention is applied. In FIG. 1, the plasma etching apparatus to which the present invention is applied comprises a processing chamber 101, an evacuation device 102, magnetic field coils 103, a gas supply device 104, a microwave oscillator 105, a gas introducing plate 106, a quartz ring 107, a component 108, a stage 109, a bias power supply 110, a susceptor 111, and a spectroscope 113.

The processing chamber 101 for performing plasma etching is a cylindrical vacuum reactor capable of achieving a vacuum degree of approximately 10⁻⁵ Pa, and the interior of the processing chamber 101 is maintained at high vacuum state or at a predetermined pressure via the evacuation device 102 equipped with an evacuation means and a pressure adjustment means disposed at a lower portion of the processing chamber.

The inner wall portion of the processing chamber 101 is grounded, and the temperature of the chamber can be controlled within a temperature range of 20 through 100° C. via a temperature control means not shown. In addition, a quartz ring 107 is disposed on the upper portion on the inner wall of the processing chamber 101, and a component 108 covered with yttria (Y₂O₃) is disposed on the lower portion thereof. A microwave oscillator 105 is disposed on the upper portion of the processing chamber 101 for generating microwaves, through which microwaves can be supplied into the processing chamber 101. Magnetic field coils 103 are arranged on the upper portion of the processing chamber 101 surrounding the outer circumference of the processing chamber, through which a magnetic field can be generated within the processing chamber 101.

A gas introducing plate 106 formed of dielectric (such as quartz) having a number of holes for supplying processing gas is disposed on the upper portion of the processing chamber 101. The processing gas can be supplied via a gas pipe into the processing chamber 101 from the gas supply device 104 equipped with a gas supply means and a gas flow rate control means disposed outside the chamber.

Furthermore, a stage 109 for mounting and supporting thereon a semiconductor wafer being the object to be processed is disposed at the lower portion in the processing chamber 101. Further, a susceptor 111 formed of quartz is disposed on the stage 109 so as to surround the object to be processed. Moreover, a bias power supply 110 capable of supplying RF bias power (frequency of 400 kHz) is connected to the stage 109 via a coaxial line.

Now, a method for performing plasma etching using the plasma etching apparatus having the above-described configuration will now be described. At first, a semiconductor wafer is placed and supported on the stage 109 within the processing chamber 101 being maintained in a high vacuum state in advance.

Thereafter, processing gas is supplied into the processing chamber 101 from a gas supply device 104. The supplied processing gas is used to efficiently generate plasma 112 via a resonance phenomenon (electron cyclotron resonance) by the microwaves generated via the microwave oscillator 105 (2.45 GHz frequency) and the magnetic field generated via the magnetic field coils 103 (8.75×10⁻² T magnetic field). The emission of plasma 112 is acquired via the spectroscope 113. During this time, the pressure within the processing chamber 101 is controlled to a predetermined pressure via the evacuation device 102.

By repeating the above plasma etching, reaction products are gradually deposited on the inner side of the processing chamber 101 of the plasma etching apparatus, and particles are generated by the deposits being detached therefrom. When this phenomenon occurs, the processing chamber 101 must be opened to outer air and subjected to wet cleaning.

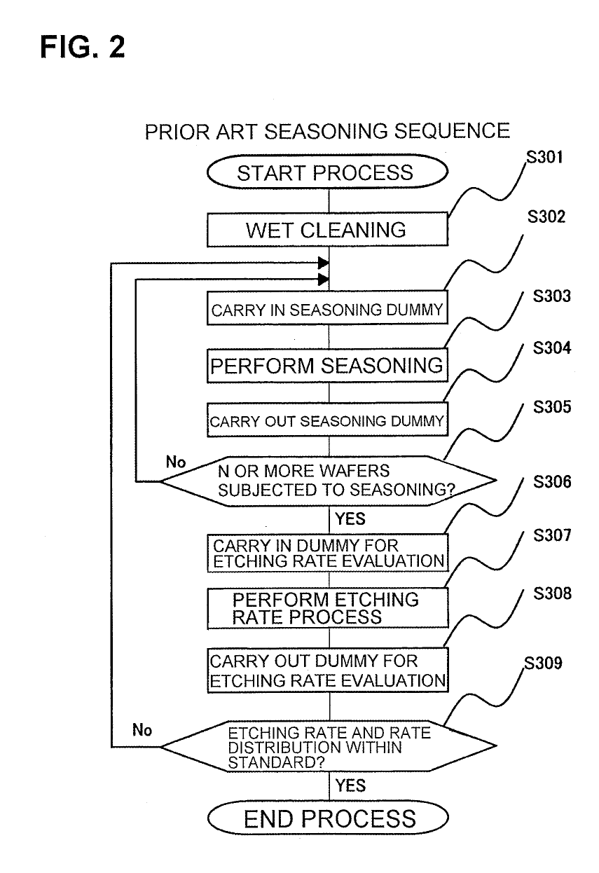

The process of a prior art seasoning performed after a wet cleaning process according to the prior art will now be described with reference to the flowchart of FIG. 2. After performing wet cleaning (S301), prior to performing mass production processing of semiconductor wafers, a seasoning dummy (sample) is carried into the processing chamber 101 and placed on the stage 109 (S302). Next, seasoning is performed (S303). The conditions of the prior art seasoning are set equal to the etching conditions for subjecting the semiconductor wafers to plasma processing during mass production with the aim to simulate the state of stable mass production (hereinafter called mass production conditions), and in patent document 1, the conditions of seasoning of step S303 are set as follows, so as to emit the yttrium (Y) on the inner wall of the processing chamber: a processing gas containing NF₃ with a flow rate of 25 ml/min, O₂ with a flow rate of 15 ml/min, and N₂ with a flow rate of 45 ml/min, and an RF bias power of 400 W.

After seasoning, the seasoning dummy (sample) is carried out of the processing chamber 101 (S304). The seasoning of step S303 is performed repeatedly until the number of seasoning samples reaches a predetermined number (N₁) set in advance (S305, total number of processed samples (N)=N₁). When seasoning has been performed to the determined number of samples (N), an etching rate wafer is carried into the processing chamber 101 and placed on the stage 109 (S306). Next, an etching rate process is performed (S307). After performing the etching rate process, the etching rate wafer is carried out of the processing chamber 101 (S308).

Next, it is determined whether the in-plane etching rate of the wafer and the in-plane rate distribution are within a standard range necessary to perform product processing. If the rate is within the standard range, seasoning is ended. If the rate falls out of the standard range, the process from steps S302 to S308 is performed again. At this time, in step S303, the number of samples to be subjected to seasoning in addition is N₂ set in advance (total number of processed samples (N)=N₁+N₂).

Now, the present invention will be described with reference to respective embodiments.

### Embodiment 1

Embodiment 1 utilizes two seasoning process conditions. A first condition is set as follows: SF₆ as processing gas with a flow rate of 85 ml/min, a chamber pressure of 0.5 Pa, a microwave output of 600 W, an RF bias power of 400 W, and an upper coil, a center coil and a lower coil set to 27 A, 26 A and 15 A, respectively (hereinafter referred to as experimental condition 1). A second condition is set as follows: NF₃ as processing gas with a flow rate of 85 ml/min, a chamber pressure of 0.5 Pa, a microwave output of 600 W, an RF bias power of 400 W, and the upper coil, the center coil and the lower coil set to 27 A, 26 A and 15 A, respectively (hereinafter referred to as experimental condition 2).

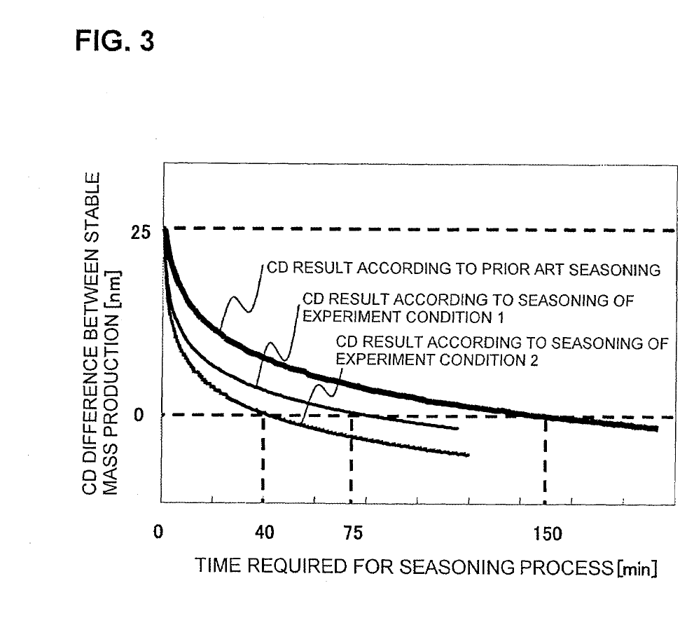

The characteristic diagram of FIG. 3 is referred to in describing the effects of embodiment 1 of the present invention. This characteristic diagram illustrates the relationship between the CD difference between stable mass production and post-seasoning and the time required for seasoning. Here, the CD difference refers to the difference between the CD after the seasoning process and the CD during stable mass production, wherein when the CD difference is zero, it is determined that the CD after seasoning corresponds to the CD during stable mass production.

In FIG. 3, according to the case where the prior art seasoning condition was applied, the time required for the chamber atmosphere to be set to the same condition as that during stable mass production via seasoning was 150 minutes, whereas according to the case where experimental condition 1 was applied, the time was reduced to 75 minutes. This shows that as disclosed in patent document 1, the increase of gas containing fluorine is effective in shortening the seasoning time.

Further, it is shown that when experimental condition 2 was applied, the above-mentioned time was significantly shortened to 40 minutes. This shows that not only fluorine gas but also nitrogen gas is effective in reducing the seasoning time.

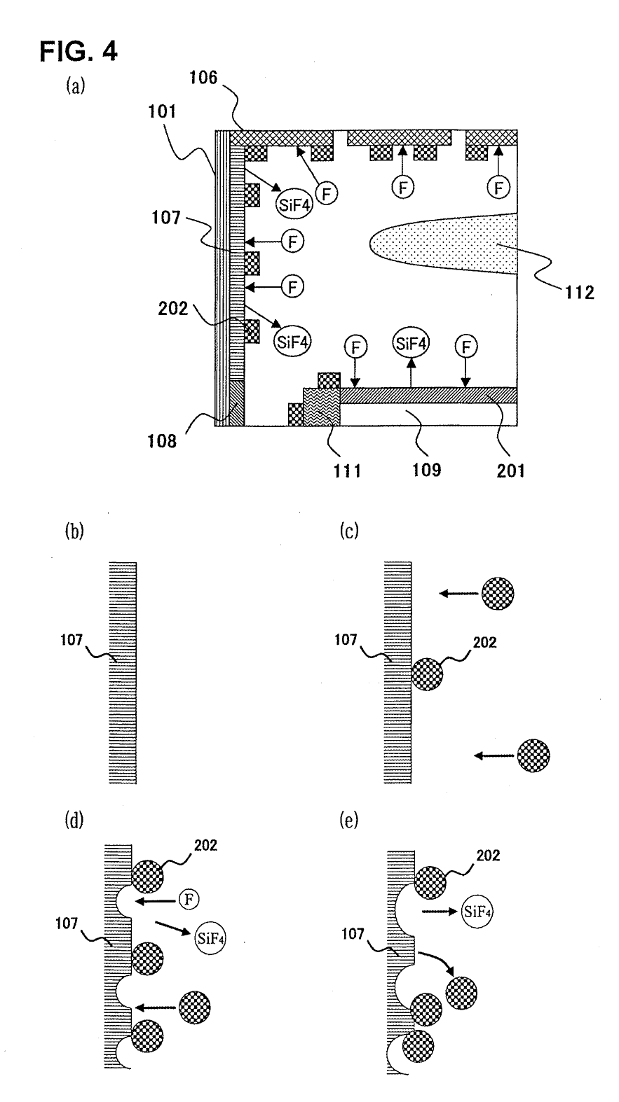

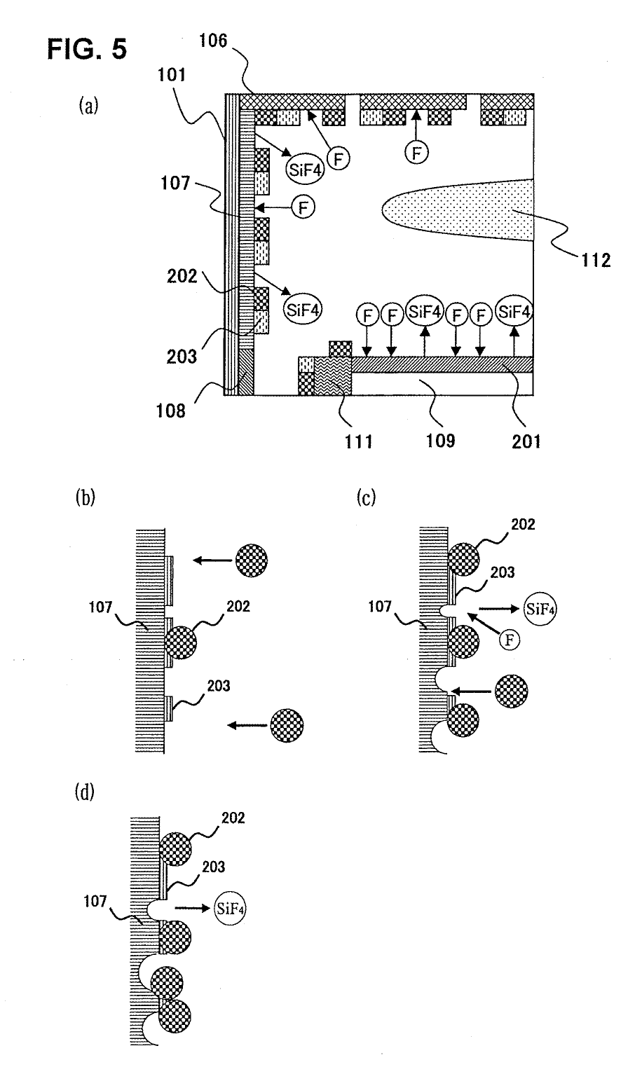

FIGS. 4 and 5 are referred to in estimating the mechanism by which the end time of seasoning was shortened from 75 minutes to 40 minutes. FIG. 4(a) is an explanatory view modeling the assumed reaction within the processing chamber when subjecting a semiconductor wafer to plasma processing after performing the first seasoning according to embodiment 1. FIG. 4(b) shows the state near the surface of a ring 107 in high vacuum. FIG. 4(c) shows a state in which ions in the plasma 112 sputter a component 108 coated with yttria (Y₂O₃) via the RF bias power set to high power, by which yttrium (Y) is emitted. The yttrium (Y) reacts with the fluorine (F) in the plasma atmosphere generating yttrium fluoride (YF₃), which sticks onto the surface of the gas introducing plate 106, the ring 107 and the susceptor 111, which are components containing silicon (Si), and acts as a protection film (protection film 202) protecting the components from the fluorine (F) in the plasma.

The silicon (Si) contained in the gas introducing plate 106, the ring 107 and the susceptor 111 not being coated by the protection film 202 reacts with the fluorine (F) in the plasma, turns into silicon fluoride (SiF₄) gas, and is evacuated through the evacuation device 102 (FIG. 4(d)).

The increase in the area of the protection film 202 coating the components containing silicon (Si) reduces the ratio of fluorine (F) consumed by the components containing silicon (Si). As a result, the ratio of fluorine (F) contributing to the etching of the semiconductor wafer 201 is increased, and the value of CD is reduced.

The fluorine used in the first seasoning condition of embodiment 1 easily reacts with silicon (Si) and is evacuated as silicon fluoride (SiF₄). At that time, the protection film 202 attached to the gas introducing plate 106, the ring 107 and the susceptor 111, which are components containing silicon (Si), are detached (hereinafter called lift-off, FIG. 4(e)).

FIG. 5(a) is an explanatory view modeling the assumed reaction within the processing chamber when subjecting a semiconductor wafer to plasma processing after performing the second seasoning according to embodiment 1.

By applying the second seasoning condition of embodiment 1, nitrogen (N) reacts with silicon (Si) and nitrides, forming a protection film 203 (FIG. 5(b)). The protection film 203 suppresses the reaction between fluorine (F) and silicon (Si) turning into silicon fluoride (SiF), and suppresses the discharge thereof (FIG. 5(c)). It is considered that as a result of this reaction, the ratio of lift-off is reduced (FIG. 5(d)).

It is assumed that as a result of the reduced ratio of lift-off and efficient attachment of the protection film 202, the reaction of the silicon (Si) in the gas introducing plate 106, the ring 107 and the susceptor 111 with the fluorine (F) in the plasma is suppressed, and the ratio of fluorine (F) contributing to the etching of the semiconductor wafer 201 is high compared to the prior art seasoning, which contributed to shortening the time required for the CD to correspond to the CD during stable mass production from 75 minutes to 40 minutes.

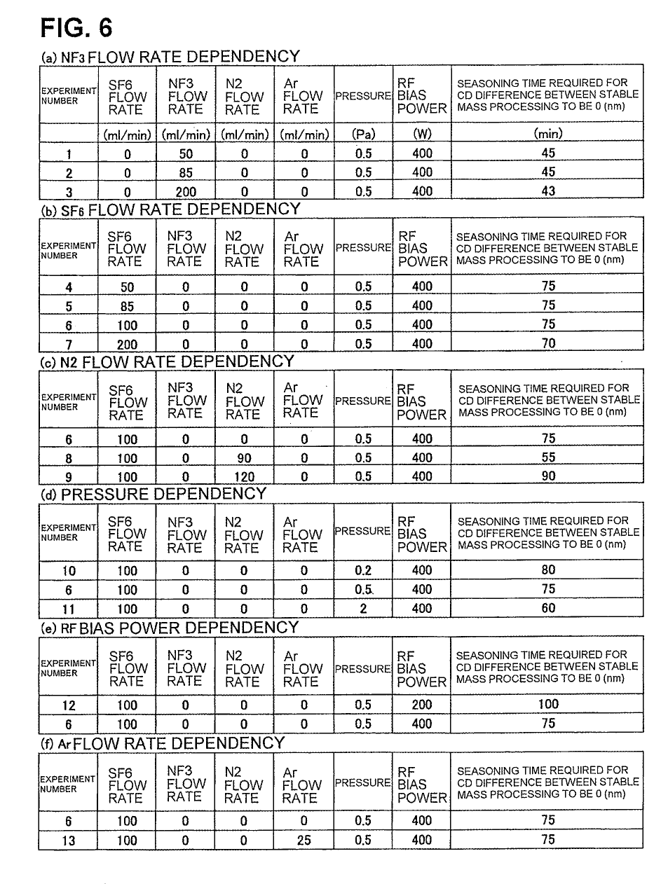

FIG. 6 is a table showing the time required for the CD to correspond to the CD during stable mass production taking experimental condition 1 as the basic condition and changing the SF₆ flow rate, the NF₃ flow rate, the nitrogen flow rate, the pressure, and the RF bias power. The conditions of FIG. 6 other than the processing gas species, the chamber pressure and the RF bias power are as follows: a microwave output of 600 W, and the upper coil, the center coil and the lower coil set to 27 A, 26 A and 15 A, respectively.

The present invention is not restricted to NF₃ and SF₆, and similar effects can be achieved using other gas species such as a fluorine-containing gas having nitrogen added thereto. For example, if 0 ml/min to 120 ml/min of nitrogen is added to SF₆, as shown in FIG. 6 (experiment numbers 6, 8 and 9: In these experiments, the SF₆ flow rate is set to 100 ml/min, but equivalent effects can be achieved by setting the SF₆ flow rate within the range of 50 ml/min to 200 ml/min.), it was confirmed that equivalent effects can be achieved by setting the flow rate of SF₆within the range of 50 ml/min to 200 ml/min (experiment numbers 4, 5, 6 and 7); the flow rate of NF₃ within the range of 50 ml/min to 200 ml/min (experiment numbers 1, 2 and 3: In these experiments, the RF bias power is set to 400 W, but similar effects can be achieve by setting the power to a range of 200 W or higher.); the processing pressure within the range of 0.2 Pa to 2.0 Pa (experiment numbers 10, 6, 11: Pressure should be as high as possible, but the range is determined arbitrarily considering the practical range of use.); and the RF bias power to a range of 200 W or higher (experiment numbers 12 and 6: In the experiments, the SF₆ flow rate is set to 100 ml/min, but equivalent effects can be achieved by setting the flow rate within the range of 50 ml/min to 200 ml/min. Further, the RF bias power should be as high as possible, but the range must be determined arbitrarily according to the power supply capacity).

Even by performing seasoning for a predetermined time adopting the seasoning conditions proposed in patent document 1 or in embodiment 1, excess or deficiency of seasoning occurs due to inter-chamber difference (machine difference), component difference during wet cleaning, and difference in operation, so the determination of the most appropriate processing time for seasoning becomes an issue.

In order to cope with this issue, a method for seasoning a plasma processing apparatus and a method for determining the end point of seasoning capable of determining the most suitable seasoning time (seasoning end point) with high repeatability will be described in embodiments 2 and 3.

### Embodiment 2

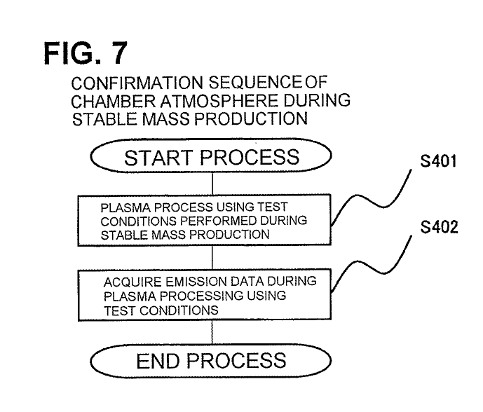

The process for confirming in advance the chamber atmosphere during stable mass production will now be described with reference to FIG. 7. In FIG. 7, in order to confirm the chamber atmosphere during stable mass production, plasma processing is performed without placing a wafer on the stage 109 (S401). In the present embodiment, the conditions for confirming the chamber atmosphere are as follows: a processing gas including 150 ml/min CF₄ gas, 30 ml/min O₂ gas ad 60 ml/min Ar gas, a chamber pressure of 0.6 Pa, a microwave output is of 1000 W, an RF bias power of 0 W, and the upper coil, the center coil and the lower coil set to 27 A, 26 A and 0 A, respectively (hereafter, in embodiment 2, these conditions are referred to as test conditions). Next, the data on the emission intensity during plasma processing using these test conditions is acquired via the spectroscope 113 (S402).

In the present embodiment, the data on silicon fluoride (SiF) and argon (Ar) are acquired. The reason for acquiring data on silicon fluoride (SiF) is, as explained in embodiment 1, that the increase of area of the protection film 202 covering the components containing silicon (Si) relates to the reduction of fluorine (F) consumed by the components containing silicon (Si). At this time, silicon fluoride (SiF) is generated by the reaction between silicon (Si) and fluorine (F), and by observing the ratio of silicon fluoride (SiF), it becomes possible to estimate the ratio of fluorine (F) contributing to the etching of the semiconductor wafer 201. The reason for acquiring data on argon (Ar) is that since it is an inert gas that does not react with other substances, it can be used for standardization. It is also possible to use helium (He) instead of argon, since it is an inert gas having similar characteristics as argon.

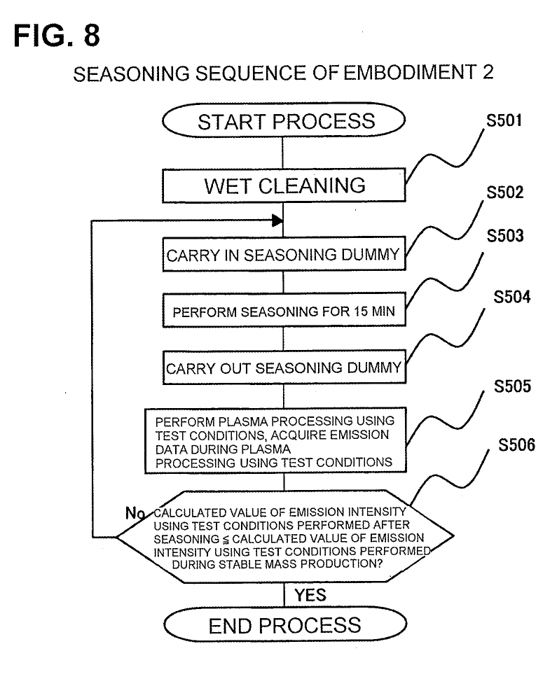

The process of seasoning to be performed after wet cleaning of embodiment 2 will now be described with reference to FIG. 8. In FIG. 8, wet cleaning is performed (S501). After wet cleaning, a seasoning dummy is carried into the processing chamber 101, and placed on the stage 109 (S502). Next, seasoning is performed (S503). The conditions for seasoning in embodiment 2 adopts the conditions for emitting yttrium (Y) from the inner wall of the processing chamber (hereinafter referred to as experimental conditions). The experimental conditions are as follows: a processing gas of SF₆ with a flow rate of 85 ml/min, a chamber pressure of 0.5 Pa, a microwave output of 600 W, an RF bias power of 400 W, and the upper coil, the center coil and the lower coil set to 27 A, 26 A and 15 A, respectively. In embodiment 2, a silicon wafer is used as the dummy wafer, and seasoning is performed for 15 minutes. By reducing the present seasoning time to less than 15 minutes, it becomes possible to confirm the chamber atmosphere in further detail.

After seasoning, the seasoning dummy is carried out of the processing chamber 101 (S504). After carrying out the seasoning dummy from the processing chamber, a plasma process is performed using test conditions (S505). At this time, the data on the emission intensity according to test conditions is acquired via the spectroscope 113. In the present embodiment, the data on silicon fluoride (SiF) and argon (Ar) are acquired.

Steps S502 through S505 are performed until the value obtained by dividing the emission intensity of silicon fluoride (SiF) with the emission intensity of argon (Ar) acquired in step S505 becomes equal to or smaller than the value obtained by dividing the emission intensity of silicon fluoride (SiF) with the emission intensity of argon (Ar) acquired in step S402, and when the value obtained by dividing the value obtained in step S505 becomes equal to or smaller than the value obtained by dividing the value obtained in step S402, the seasoning is ended (S506).

According to the present embodiment, equivalent effects could be achieved using the conditions shown in FIG. 6.

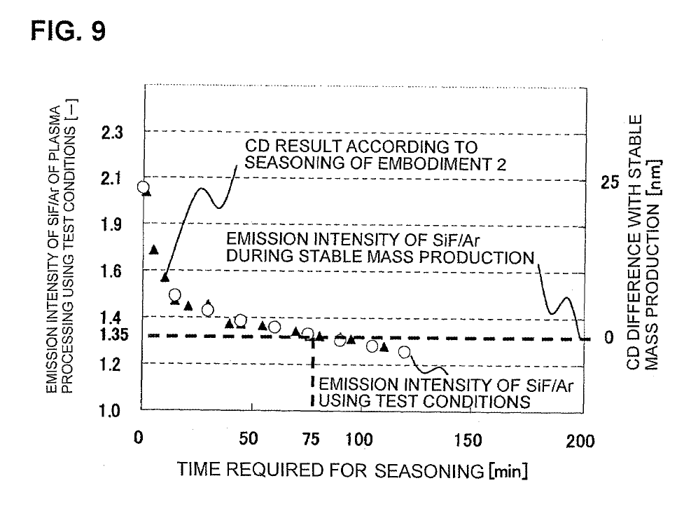

The characteristic diagram of FIG. 9 is used to describe the relationship between the emission intensity during plasma processing using the test conditions of embodiment 2, the CD difference between during seasoning and during stable mass production, and the time required for the seasoning process.

The Y1 axis of FIG. 9 shows values (white circles) obtained by dividing the emission intensity of silicon fluoride (SiF) with the emission intensity of argon (Ar) acquired in step S503. The value obtained by dividing the emission intensity of silicon fluoride (SiF) with the emission intensity of argon (Ar) acquired in step S402 is 1.35. The Y2 axis of FIG. 9 shows the CD difference (black triangles) between those during seasoning of embodiment 2 and those during stable mass production. CD difference refers to the difference between the CD during seasoning of embodiment 2 and the CD during stable mass production, wherein when the CD difference is zero, it is determined that the CD during seasoning of embodiment 2 corresponds to the CD during stable mass production.

FIG. 9 shows that there is a strong correlation between the calculated value of emission intensity (SiF/Ar) acquired during the plasma processing using the test conditions and the CD difference. From the present results, the end of seasoning can be determined by observing the calculated value of emission intensities (SiF/Ar) acquired during the plasma processing using the test conditions.

### Embodiment 3

In embodiment 2, plasma processing using test conditions were performed in order to determine the end of seasoning in step S506 of the seasoning sequence of FIG. 8. In embodiment 3, we will describe a method for determining the end of seasoning by observing the emission during seasoning in real time.

The detailed description of FIG. 7 illustrating the steps for confirming the chamber atmosphere during stable mass production is omitted, since it is the same as embodiment 2.

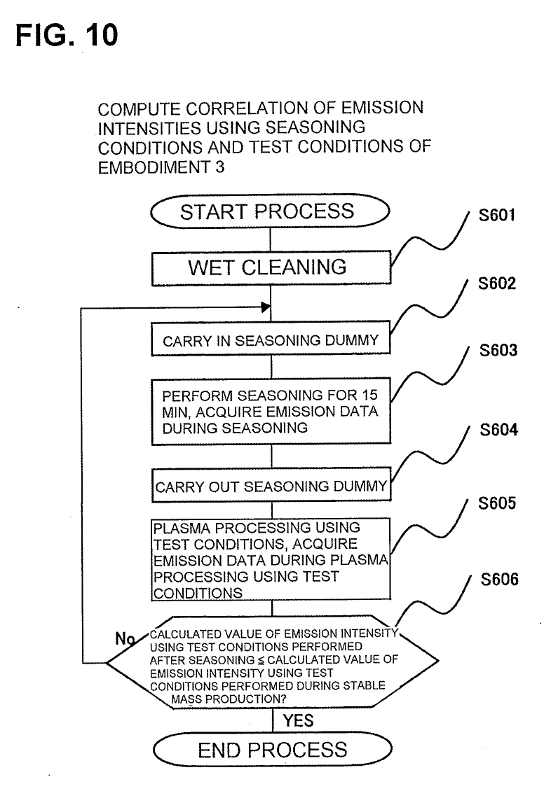

FIG. 10 is referred to in describing the steps for computing the correlation between the seasoning conditions of embodiment 3 and the emission intensity of test conditions after seasoning. In FIG. 10, wet cleaning is performed (S601). After wet cleaning, a seasoning dummy is carried into the processing chamber 101 and placed on the stage 109 (S602). After carrying the seasoning dummy into the processing chamber, the seasoning is performed (S603). The conditions used for seasoning of embodiment 3 are the conditions for emitting the yttrium (Y) from the inner wall of the processing chamber (hereinafter called experiment conditions in embodiment 3). The experiment conditions are as follows: a processing gas of SF₆ with a flow rate of 100 ml/min, an Ar flow rate of 25 ml/min, a chamber pressure of 0.5 Pa, a microwave output of 600 W, an RF bias power of 400 W, and the upper coil, the center coil and the lower coil set to 27 A, 26 A and 15 A, respectively.

After seasoning, the seasoning dummy is carried out of the processing chamber 101 (S604).

In embodiment 3, a silicon wafer is used as the seasoning dummy, and seasoning is performed for 15 minutes. By reducing the seasoning time to less than 15 minutes, the reliability of the correlation between seasoning conditions and test conditions can be improved. Thereafter, the dummy wafer is carried out of the processing chamber 101. Further, the data on the emission intensity during seasoning is acquired via the spectroscope 113. In the present embodiment, the data on silicon fluoride (SiF) and argon (Ar) at that time are acquired.

After carrying out the dummy wafer for seasoning from the processing chamber, a plasma process using test conditions is performed (S605). At this time, the data on the emission intensity using the test conditions is acquired via the spectroscope 113. In the present embodiment, the data on silicon fluoride (SiF) and argon (Ar) are acquired.

Steps S602 through S605 are performed until the value obtained by dividing the emission intensity of silicon fluoride (SiF) with the emission intensity of argon (Ar) acquired in step S605 becomes equal to or smaller than the value obtained by dividing the emission intensity of silicon fluoride (SiF) with the emission intensity of argon (Ar) acquired in step S402 (the chamber atmosphere during mass production), and when the chamber atmosphere after the seasoning process becomes equal to or smaller than the chamber atmosphere during mass production, the seasoning is ended (S606).

According to the present embodiment, equivalent effects could be achieved using the conditions shown in FIG. 6.

The characteristic diagram of FIG. 10 is used to describe the relationship between the emission intensity of seasoning condition used in embodiment 3, the emission intensity of plasma processing using test conditions, and the emission intensity during plasma processing using the test conditions during stable mass production. In FIG. 10, the values obtained by dividing the emission intensities of silicon fluoride (SiF) with the emission intensities of argon (Ar) acquired in step S602 are plotted in the Y1 axis (crosses), and the values obtained by dividing the emission intensities of silicon fluoride (SiF) with the emission intensities of argon (Ar) acquired in step S603 are potted in Y2 axis (circles). The correlation coefficient of these two values is 0.999. It can be recognized that the value calculated from the emission intensities using the seasoning conditions of embodiment 3 and the values calculated from the emission intensities of plasma processing using test conditions are strongly correlated.

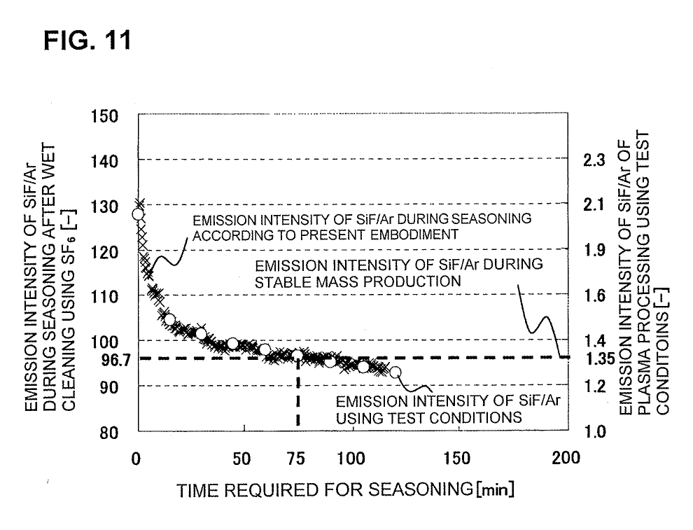

Furthermore, the value obtained by dividing the emission intensity of silicon fluoride (SiF) with the emission intensity of argon (Ar) acquired in step S402 (SiF/Ar during stable mass production) is 1.35 shown in the Y2 axis of FIG. 11. This value converted into the value obtained by dividing the emission intensity of silicon fluoride (SiF) with the emission intensity of argon (Ar) during seasoning of embodiment 3 is 96.7 shown in the Y1 axis of FIG. 11.

As described, the correlation calculated in FIGS. 10 and 11 should only be acquired once for the initial time. From the second time onward, the calculated value of emission intensity (SiF/Ar) acquired during seasoning based on the correlation computed via FIGS. 10 and 11 can be used.

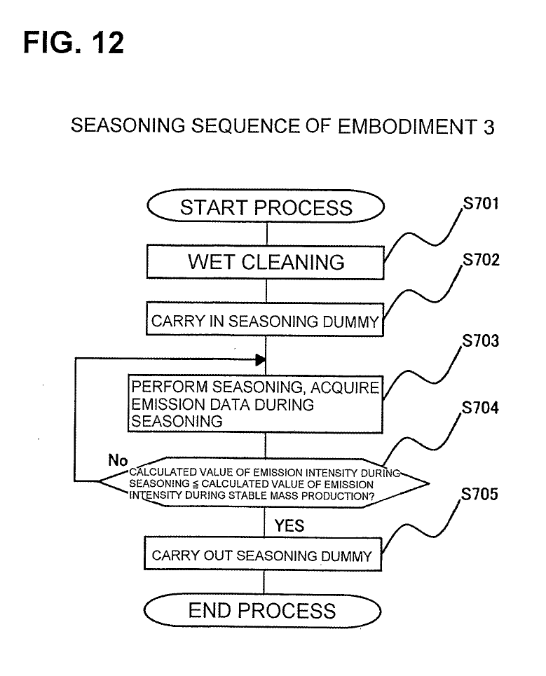

The steps of seasoning after performing wet cleaning according to embodiment 3 will be described with reference to FIG. 12. In FIG. 12, wet cleaning is performed (S701). After wet cleaning, a seasoning dummy is carried into the processing chamber 101 and placed on the stage 109 (S702). Next, simultaneously as performing seasoning, the data on the emission intensities of silicon fluoride (SiF) and argon (Ar) during seasoning are acquired in real time (S703). The experiment conditions used in the present embodiment are the same as the conditions of step S602 excluding the processing time. The present processing time is determined by an automatic end determination.

After seasoning, step S703 is performed until the value obtained by dividing the emission intensity of silicon fluoride (SiF) with the emission intensity of argon (Ar) acquired in step S703 becomes equal to or smaller than 96.7, which is a value representing the chamber atmosphere during stable mass production (S704), and when the value becomes equal to or smaller than 96.7, the seasoning dummy is carried out of the processing chamber 101 (S705).

From FIG. 11, there is a strong correlation between the calculated value of emission intensity (SiF/Ar) acquired during seasoning and the calculated value of emission intensity (SiF/Ar) acquired during plasma processing using test conditions. By observing the calculated value of emission intensity (SiF/Ar) acquired during seasoning based on the correlation, the end of the seasoning can be determined.

According to the embodiments of the present invention, an ECR (electron cyclotron resonance) plasma processing apparatus was used, but the present invention is not restricted to such apparatus, and can be applied to apparatuses utilizing other methods for generating plasma, such as ICP (inductively coupled plasma) and CCP (capacitively coupled plasma).

According to the embodiments of the present invention, yttria (Y₂O₃) was used as the earth portion in the inner wall of the processing chamber, but the present invention is not restricted to the use of yttria (Y₂O₃), and other plasma-resistant materials including yttrium (Y) having yttrium fluoride (YF₃) as main component or aluminum (Al) having aluminum oxide (Al₂O₃) as main component can be used.

The present invention enables to provide a method for seasoning a plasma processing apparatus and a method for determining the end point of seasoning, capable of reducing the time required for seasoning after performing wet cleaning, and capable of determining the optimum seasoning time with superior repeatability.

What is claimed is:

1. A method for seasoning a plasma processing apparatus for subjecting a seasoning sample to plasma processing using a plasma formed of a seasoning gas introduced into a processing chamber having been subjected to wet cleaning, the method comprising:
seasoning the processing chamber by using as a seasoning gas selected from a group consisting of SF₆ with a flow rate of 200 ml/min or smaller, preferably 85 ml/min or smaller and 50 ml/min or greater, NF₃ with a flow rate of 200 ml/min or smaller, preferably 85 ml/min or smaller and 50 ml/min or greater, and SF₆ with a flow rate of 200 ml/min or smaller and 50 ml/min or greater containing N at a flow ratio of 120% or smaller and 0% or greater, and controlling an RF bias power to 200 W or greater, preferably to 400 W.

2. A method for determining an end point of seasoning of a plasma processing apparatus for subjecting a seasoning sample to plasma processing using a plasma formed of a seasoning gas introduced into a processing chamber having been subjected to wet cleaning, the method comprising:
seasoning the processing chamber using SF₆ gas with a flow rate of 200 ml/min or smaller, preferably 85 ml/min or smaller and 50 ml/min or greater as seasoning gas, and controlling an RF bias power to 200 W or greater, preferably to 400 W, and after performing seasoning, acquiring a data on emission intensities of silicon fluoride (SiF) and argon (Ar) during plasma processing using test conditions; and
performing seasoning until a value obtained by dividing the acquired emission intensity of silicon fluoride (SiF) with the emission intensity of argon (Ar) becomes equal to or smaller than a value obtained by dividing an emission intensity of silicon fluoride (SiF) with an emission intensity of argon (Ar) acquired in advance in a chamber atmosphere during stable mass production, and ending the seasoning when the value acquired using test conditions becomes equal to or smaller than the value acquired during stable mass production.

3. A method for determining an end point of seasoning of a plasma processing apparatus for subjecting a seasoning sample to plasma processing using a plasma formed of a seasoning gas introduced into a processing chamber having been subjected to wet cleaning, the method comprising:
seasoning the processing chamber using SF₆ gas with a flow rate of 200 ml/min or smaller, preferably 85 ml/min or smaller and 50 ml/min or greater as seasoning gas, and controlling an RF bias power to 200 W or greater, preferably to 400 W, and acquiring a data on emission intensities of silicon fluoride (SiF) and argon (Ar) during the seasoning; and
performing seasoning until a value obtained by dividing the emission intensity of silicon fluoride (SiF) with the emission intensity of argon (Ar) acquired during seasoning becomes equal to or smaller than a value obtained by dividing an emission intensity of silicon fluoride (SiF) with an emission intensity of argon (Ar) acquired in advance in a chamber atmosphere during stable mass production, and ending the seasoning when the value acquired during seasoning becomes equal to or smaller than the value acquired during stable mass production.

4. The method for determining the end point of seasoning of the plasma processing apparatus according to claim 3, further comprising:
computing a correlation between the calculated value of emission intensities (SiF/Ar) acquired during seasoning using the seasoning sample and the calculated value of emission intensities (SiF/Ar) acquired during plasma processing using test conditions after performing the seasoning; and
determining the end of seasoning by observing the calculated value of emission intensities (SiF/Ar) acquired during seasoning based on the correlation.

5. The method for determining the end point of seasoning of the plasma processing apparatus according to claim 2, wherein the plasma process performed using test conditions is
performed by carrying out the seasoning sample after seasoning the processing chamber, and thereafter, using CF₄ gas, O₂ gas and Ar gas as cleaning gas.

6. The method for determining the end point of seasoning of the plasma processing apparatus according to claims 2 through 4, wherein
the chamber atmosphere during stable mass production has no wafer placed on the stage and uses CF₄ gas, O₂ gas and Ar gas as cleaning gas.
